(19) United States
(12) Patent Application Publication
(10) Pub. No.: US 2009/0198409 A1
(43) Pub. Date: Aug. 6, 2009

(54) Work tool data system

(75) Inventors: Stephen William Rector, Metamora, IL (US); Robert J. Price, Dunlap, IL (US); Ujwal Kumar Dandgey, Peoria, IL (US); Glen Jay Grimstad Johnson, Oro Valley, AZ (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/068,027

(22) Filed: Jan. 31, 2008

(51) Int. Cl. G01M 17/00

(52) U.S. Cl. 701/35

(57) ABSTRACT

The present disclosure is directed to a data system for use with a work tool. The data system may have a processing device and a data storage device in communication with the processing device. The data storage device may be located on a work tool and be configured to log at least one of a usage time of the work tool and a warning event associated with the work tool.

### TECHNICAL FIELD

The present disclosure relates generally to a data system and, more particularly, to a data system for use with a work tool.

### BACKGROUND

Machines, such as excavators, wheel loaders, skid steer loaders, and other types of machines, often have the capability of utilizing multiple attachable work tools (e.g., bucket, hammer, blade, etc.) to perform work operations. For example, an operator may attach a bucket to a machine to perform a digging operation and then detach the bucket and attach a hammer to the machine to perform a breaking operation. However, having multiple attachable work tools for one or more machines may result in work tool usage and wear that is difficult to track, thus potentially leading to unexpected breakdown of a work tool.

One method of tracking tool usage is disclosed in U.S. Patent Publication No. 2005/0283295 (the '295 publication) by Normann, published on Dec. 22, 2005. The '295 publication discloses a machine operating system having at least one work tool, a sensor configured to sense an operational characteristic of the machine, and a control unit. In some embodiments, an electric control may be located on the work tool of the machine. The electric control may be an electronic control module, a system computer, a central processing unit, or other data storage and manipulation device known in the art. The electric control may be in communication with sensors located on the machine and/or work tool and may also be in communication with operator interfaces, work tool controls, and/or the control unit.

The control unit may be capable of identifying the work tool attached to the machine. For example, the machine may include a tool identification device such as, an optical, infra-red, or inductive sensor, and the work tool may include an appropriate signal transmitter. Once the operator indicates that the tool has been correctly identified, the control unit may use the tool identification information to assist in altering operation of the machine. It may also store the tool identification information in conjunction with, for example, a number of hours the particular tool was used with the machine. Tool identification and usage information may be retrieved and downloaded from the control unit to, for example, a computer terminal or laptop for analysis.

Although the machine of the '295 publication may store the number of hours the particular tool was used with the machine, it may still be improved. Specifically, since the number of usage hours is stored on the machine currently using the tool (or downloaded to a computer terminal), when a particular tool is frequently used between multiple machines or bought and sold between multiple owners, the total usage hours for a particular tool may be out of date, unobtainable, or incorrect.

The disclosed tool system is directed to overcoming one or more of the problems set forth above.

### SUMMARY

In one aspect, the present disclosure is directed to a data system for use with a work tool. The data system may include a processing device and a data storage device in communication with the processing device. The data storage device may be located on a work tool and be configured to log at least one of a usage time of the work tool and a warning event associated with the work tool.

In another aspect, the present disclosure is directed to a method of tracking work tool usage. The method may include determining at least one of a usage time and a warning event associated with a work tool. The method may also include logging at least one of the usage time and the warning event onto a data storage device located on the work tool. The method may further include communicating with the data storage device and displaying at least one of the usage time and the warning event of the work tool.

### BRIEF DESCRIPTION OF THE DRAWINGS

FIG. 1 is a diagrammatic illustration of an exemplary disclosed machine;

FIG. 2 is a schematic and diagrammatic illustration of an exemplary work tool data system that may be used with the machine of FIG. 1; and

FIG. 3 is a flowchart depicting an exemplary operation of the work tool data system illustrated in FIG. 2.

### DETAILED DESCRIPTION

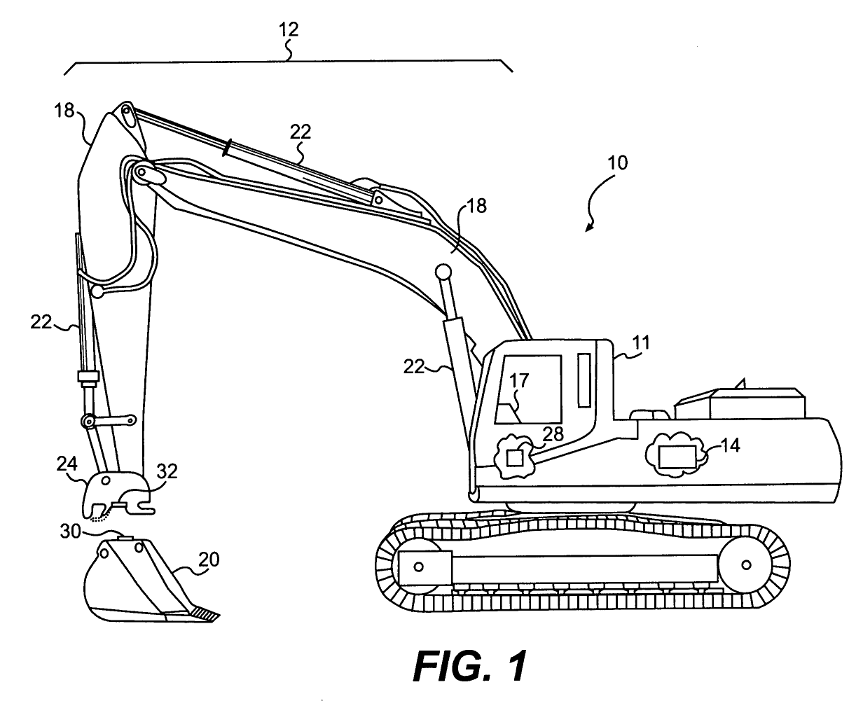

FIG. 1 illustrates an exemplary machine 10. Machine 10 may be a machine that performs some type of operation associated with an industry such as mining, construction, farming, transportation, or any other industry known in the art. For example, machine 10 may be an earth moving machine, such as an excavator, a wheel loader, a skid steer loader, a backhoe, or any other suitable earth moving machine known in the art. Machine 10 may include an operator station 11, a work implement 12, and a hydraulic system 14 that provides pressurized fluid for work implement 12.

Operator station 11 may be a location from which an operator may control machine 10. Operator station 11 may be located on or off of machine 10 and may include operator input devices (not shown) and/or an operator display 17. Operator display 17 may provide information regarding the operation or performance of machine 10. It is contemplated that operator display 17 may include one or more audio and/or visual devices (e.g., a display screen with a speaker). It is also contemplated that operator display 17 may alternatively or additionally be located on a separate handheld device (e.g., a laptop, PDA, etc.).

Work implement 12 may include one or more linkage members 18 and a work tool 20. Linkage members 18 may, for example, include a boom member and a stick member. In one embodiment, a first end of the boom member may be pivotally connected to machine 10 and a second end of the boom member may be pivotally connected to a first end of the stick member. A second end of the stick member may be connected to a coupling mechanism 24. It is contemplated that each of linkage members 18 may be actuated by one or more actuators 22.

Work tool 20 may be any interchangeable tool that may be used to perform a task. Work tool 20 may embody, for example, a bucket, a grappler, a hammer, a fork, a lifting hook, a saw, a rotary broom, a shear, or any other appropriate work tool known in the art. Work tool 20 may be connected to a second end of the stick member via coupling mechanism 24.

Coupling mechanism 24 may be any appropriate mechanism that mechanically couples linkage members 18 to any one of a plurality of different work tools (e.g., quick coupler, pin on mechanism, etc.). Coupling mechanism 24 may also include coupling devices (not shown) for hydraulically and/or electrically transmitting power to work tool 20 (i.e., provide hydraulic fluid and/or electrical power/signals to work tool 20).

Actuators 22 may be hydraulic cylinders that actuate linkage members 18. Actuators 22 may be selectively supplied with a pressurized fluid and drained of the pressurized fluid to create axial displacement, thus causing linkage members 18 to pivot. It is contemplated that actuators 22 may alternatively embody electric motors, pneumatic motors, or any other actuation devices known in the art.

Hydraulic system 14 may provide pressurized fluid to each actuator 22. It is contemplated that hydraulic system 14 may also supply pressurized fluid for operation of work tool 20. For example, when work tool 20 embodies a hammer or grappler, hydraulic system 14 may supply fluid for actuation of the hammer or grappler.

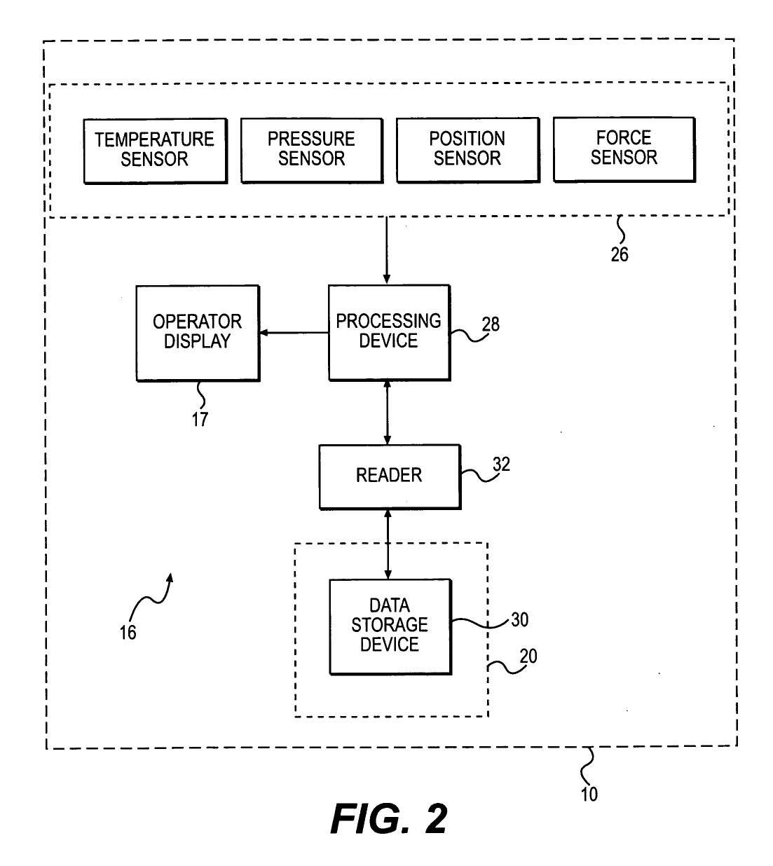

As shown in FIG. 2, machine 10 may also include a work tool data system 16. Work tool data system 16 may include one or more sensors 26, a processing device 28, a reader 32, and a data storage device 30 (data storage device 30 may be located on work tool 20). Work tool data system 16 may be configured to identify which work tool 20 is currently attached to work implement 12. Work tool data system 16 may also be configured to use work tool parameters (e.g., hydraulic, electrical, and kinematic parameters) stored on data storage device 30 to control various machine systems (e.g., hydraulic system 14, etc.). The work tool parameters may be retrieved by processing device 28 from data storage device 30 after or while a work tool 20 is being connected to machine 10. Work tool data system 16 may also be configured to store information back onto data storage device 30, such as, for example, information obtained from sensors 26 and processing device 28 regarding usage of work tool 20.

Sensors 26 may sense a state or a change in the state of one or more components of machine 10 associated with work tool 20. For example, sensors 26 may include angle or position sensing devices (e.g., rotary encoders, potentiometers, etc.) located near joints of linkage members 18 or work tool 20. Sensors 26 may also include force sensing devices (e.g., strain gauges, piezoelectric transducers, etc.) configured to measure forces or torques experienced by actuators 22, linkage members 18, and/or work tool 20. Sensors 26 may include pressure or flow sensing devices configured to measure a pressure or a flow of the hydraulic fluid supplied to work tool 20. Sensors 26 may further include temperature sensors (e.g., thermocouples) configured to sense a temperature of the hydraulic fluid supplied to work tool 20.

Processing device 28 may embody a single microprocessor or multiple microprocessors. Numerous commercially available microprocessors may be configured to perform the functions of processing device 28, and it should be appreciated that processing device 28 may readily embody a general machine microprocessor capable of monitoring and/or controlling numerous machine functions. Processing device 28 may include a memory, a secondary storage device, a processor, and any other components for running an application. Various other circuits may be associated with processing device 28, such as, for example, power supply circuitry, signal conditioning circuitry, data acquisition circuitry, signal output circuitry, signal amplification circuitry, and other types of circuitry known in the art. Processing device 28 may include one or more maps stored within the internal memory of processing device 28. Each of these maps may include a collection of data in the form of tables, graphs, and/or equations. Processing device 28 may communicate with sensors 26, operator display 17, reader 32, and data storage device 30 (e.g., via reader 32). It is contemplated that processing device 28 may also communicate (not shown) with a power source, operator station 11, hydraulic system 14, and/or other components of machine 10.

Reader 32 may include or embody an antenna (e.g., RF antenna), an infra-red device, or an inductive device, or any other device known in the art. Reader 32 may wirelessly send signals to and receive signals from data storage device 30. Reader 32 may be located on coupling mechanism 24 (see FIG. 1), linkage members 18, operator station 11, or in any other appropriate location. It is contemplated that processing device 28 may alternatively be directly connected to data storage device 30 using male and female connecters. It is also contemplated that processing device 28 may use reader 32 and/or an operator input received from an operator input device (not shown) to determine when work tool 20 is connected to machine 10.

Data storage device 30 may be any appropriate device configured to store work tool information and communicate with reader 32. Data storage device 30 may be located on work tool 20 and may embody a passive or an active device, and may communicate with reader 32 via, for example, an antenna (e.g., RF antenna), an optical device, an infra-red device, or an inductive device. In one embodiment, data storage device 30 may be an RFID device or RF tag. Data storage device 30 may also include a computer readable medium or memory (e.g., flash, magnetic type memory, etc.). It is contemplated that processing device 28 may read work tool information from and write work tool information to data storage device 30. The work tool information stored and retrieved from data storage device 30 may include work tool parameters, work tool usage data, and work tool identification data.

Work tool parameters may include hydraulic, electrical, and kinematic parameters used by processing device 28 to control the systems of machine 10 to utilize a given work tool 20. The work tool parameters may include the type of work tool 20, dimensions of work tool 20, mass and/or inertia of work tool 20, hydraulic pressures and flows for operation of work tool 20 (e.g., desired flow rate and/or pressure of the hydraulic fluid supplied from hydraulic system 14 to work tool 20), and/or other appropriate work tool parameters. Work tool parameters may also include set limits for use of work tool 20. For example, the set limits may include a limit on a maximum angle at which work tool 20 may be used, a maximum hydraulic fluid pressure and/or flow rate for work tool 20, a maximum force or torque experienced by work tool 20 and/or a work tool linkage, and a maximum temperature of the hydraulic fluid supplied to work tool 20. The work tool parameters may be determined by a machine manufacturer and saved onto data storage device 30. It is contemplated that the set limits may be hard limits (i.e., machine 10 may be restrained from exceeding the limit), soft limits (i.e., machine 10 may exceed the limit), or a combination of both hard and soft limits.

Work tool usage information may include work tool usage time, warning events, a duration of the warning events, and/or any other appropriate work tool usage information known in the art. Work tool usage information may also include servicing information, such as, for example, date of servicing of work tool 20, name of technician who serviced work tool 20, servicing tasks performed on work tool, etc. It is contemplated that servicing information may be communicated to data storage device 30 by an external device (e.g., laptop computer, cell phone, PDA, etc.)

Work tool usage time may include the total time that work tool 20 has been used by a particular machine during the current instance (current usage time), the total time that work tool 20 has been used by the particular machine in any instance (total machine usage time), and/or the total time that work tool 20 has been utilized by any machine (lifetime usage time). Processing device 28 may include a timer and may log the usage time for each usage of work tool 20 onto data storage device 30. The work tool usage time stored on data storage device 30 may be continuously updated during usage of work tool 20 or it may be stored onto data storage device 30 prior to work tool 20 being disconnected from machine 10.

Warning events may result when data from sensors 26 indicates that a work tool set limit has been violated. For example, when the set limit is a hard limit, warning events may result when the current angle, force, torque, fluid temperature, fluid pressure, and/or fluid flow rate for work tool 20 is substantially equal to the maximum angle, force, torque, fluid temperature, fluid pressure, and/or fluid flow rate for work tool 20. However, when the set limit is a soft limit, warning events may result when the current angle, force, torque, fluid temperature, fluid pressure, and/or fluid flow rate for work tool 20 is substantially equal to or greater than the maximum angle, force, torque, fluid temperature, fluid pressure, and/or fluid flow rate for work tool 20. Processing device 28 may log the warning event and any sensor values associated with the warning event onto data storage device 30.

Work tool identification data may include owner information (e.g., contact information), manufacturer information (e.g., contact information, date and place of manufacture or remanufacture of work tool 20) and any other appropriate information for identification of work tool 20.

It is contemplated that one or more items of the work tool information (i.e., work tool parameters, work tool usage data, and work tool identification data) may be encrypted onto data storage device 30 and retrievable and/or modifiable using one or more passwords. The work tool information may be retrieved and/or modified by an external device (e.g., laptop computer, cell phone, PDA, etc.) or internal device (e.g., processing device 28) communicating with data storage device 30 and inputting the correct one or more passwords.

### INDUSTRIAL APPLICABILITY

The disclosed work tool data system may be applicable to any machine that is capable of utilizing a plurality of different work tools. The disclosed work tool data system may accurately track work tool information and store this information on a data storage device. The work tool information may then be available for retrieval and display even when the work tool is being or has been used by multiple different machines. Work tool data system 16 will now be described.

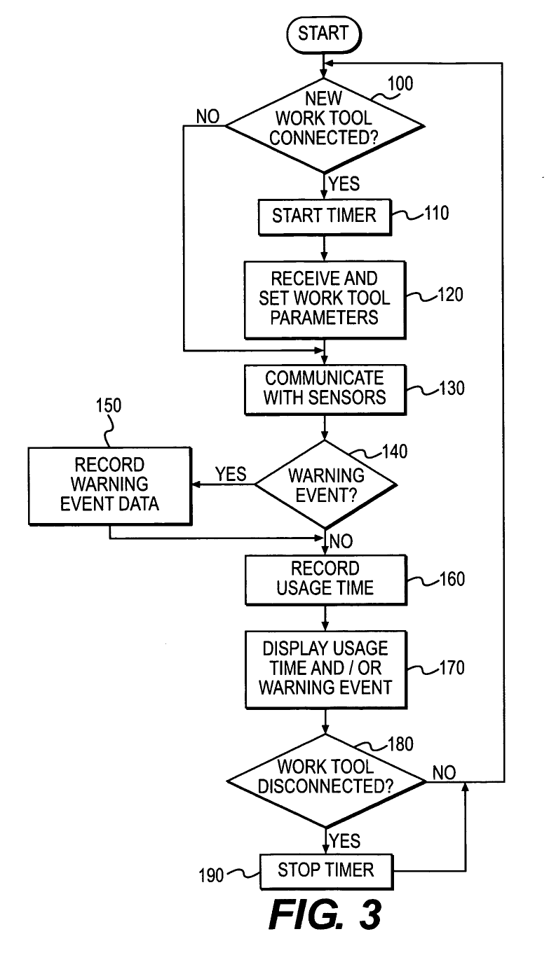

As shown in FIG. 3, processing device 28 may communicate with reader 32 to determine if a new work tool 20 is connected (step 100). If a new work tool 20 is connected, processing device 28 may start tracking the time elapsed since connection (step 10). Processing device 28 may receive from data storage device 30 the work tool parameters (step 120). Processing device 28 may then set the work tool parameters (step 120), or in other words, processing device 28 may use the work tool parameters to control various machine systems (e.g., hydraulic system 14). The setting of the work tool parameters may be done automatically without any operator intervention required. For example, if the new work tool 20 embodies a hammer, processing device 28 may receive the hammer's work tool parameters from data storage device 30 and then automatically use the work tool parameters to set the flow rate and/or pressure of the hydraulic fluid supplied from hydraulic system 14 to the hammer. It is contemplated that the work tool parameters utilized by machine 10 may also be modified or adjusted by a device (e.g., processing device 28, a laptop computer, etc.) communicating with data storage device 30 and inputting the correct passwords in order to unencrypt the data for retrieval and modification.

Processing device 28 may communicate with and receive data from sensors 26 (step 130). For example, processing device 28 may communicate with sensors 26 to determine an angle or position of linkage members 18 or work tool 20, a force or a torque experienced by work tool 20, a pressure or a flow rate of the hydraulic fluid supplied to work tool 20, and/or a temperature of the hydraulic fluid supplied to work tool 20.

Processing device 28 may compare the sensor data to the work tool set limits to determine if a warning event has occurred (step 140). For example, a warning event may occur if the hammer is used on an inappropriate angle that exceeds or is equal to the maximum allowable angle for the hammer. If a warning event has occurred, processing device 28 may respond by logging the occurrence of the warning event and/or any sensor data or information associated with the warning event (e.g., duration of the warning event) onto data storage device 30 (step 150). The sensor data associated with the warning event may include, for example, the measurements from sensors 26 (e.g., angle, force, torque, fluid temperature, fluid pressure, and/or fluid flow rate for work tool), the duration of the set limit violation, and any other appropriate sensor data.

Processing device 28 may record the work tool usage time onto data storage device 30 (step 160). Specifically, processing device 28 may refer to the timer and record onto data storage device 30 the current usage time, the total machine usage time, and the lifetime usage time for work tool 20. It is also contemplated that the work tool usage time (i.e., current, total machine, and/or lifetime usage time) may alternatively be stored onto data storage device 30 prior to work tool 20 being disconnected from machine 10 (rather than continuously updated during operation). The work tool usage time and any warning events may additionally be displayed on operator display 17 (step 170).

Processing device 28 may determine if work tool 20 is disconnected by using reader 32 and/or a received operator input (step 180). If work tool 20 is disconnected, processing device 28 may stop tracking the elapsed time (step 190) and return to step 100. Alternatively, processing device 28 may return directly to step 100.

Several advantages of the disclosed work tool data system may be realized. In particular, by storing the usage time of a particular work tool onto a data storage device located on the work tool, the usage time for the work tool may be accurately tracked and available for immediate retrieval and display even when the tool is being used or has been used by multiple different machines and/or owners. Other usage information regarding the tool may also available for determination of potential repair needs of the work tool. The disclosed system may also configure the work tool and record information regarding the work tool automatically, thus minimizing potential operator errors.

It will be apparent to those skilled in the art that various modifications and variations can be made to the disclosed work tool data system without departing from the scope of the disclosure. Other embodiments of the work tool data system will be apparent to those skilled in the art from consideration of the specification and practice of the work tool data system disclosed herein. It is intended that the specification and examples be considered as exemplary only, with a true scope being indicated by the following claims.

1. A data system for use with a work tool, comprising:
a processing device; and
a data storage device in communication with the processing device, the data storage device being located on the work tool and being configured to log a warning event associated with the work tool.

2. The work tool data system of claim 1, further including a reader configured to communicate wirelessly with the data storage device.

3. The work tool data system of claim 1, wherein the data storage device is configured to store work tool parameters and the processing device is configured to automatically access the work tool parameters.

4. The work tool data system of claim 3, wherein the processing device is configured to use the work tool parameters to operate the work tool.

5. The work tool data system of claim 1, further including at least one sensor, wherein the processing device determines a warning event by communicating with the at least one sensor and comparing the sensor data to set limits.

6. The work tool data system of claim 5, wherein the data storage device is configured to log a usage time of the work tool, and wherein the processing device is in communication with a display device and the display device is configured to display the usage time of the work tool and any warning event associated with the work tool.

7. The work tool data system of claim 5, wherein the set limits include at least one of a limit on a maximum angle at which the work tool can be used, a maximum pressure of a hydraulic fluid supplied to the work tool, a maximum force or torque experienced by the work tool, and a maximum temperature of the hydraulic fluid supplied to the work tool.

8. The work tool data system of claim 1, wherein the data storage device is configured to store work tool identification data.

9. The work tool data system of claim 8, wherein at least one of the work tool identification data, a usage time of the work tool, and any warning event associated with the work tool is encrypted onto the data storage device.

10. A method of tracking work tool usage, comprising:
determining a warning event associated with a work tool; logging the warning event onto a data storage device located on the work tool; and
communicating with the data storage device and displaying the warning event of the work tool.

11. The method of claim 10, wherein determining the warning event is determined by comparing data received from one or more sensors to set limits.

12. The method of claim 11, wherein the set limits include at least one of a limit on a maximum angle at which the work tool can be used, a maximum pressure of a hydraulic fluid supplied to the work tool, a maximum force or torque experienced by the work tool, and a maximum temperature of the hydraulic fluid supplied to the work tool.

13. The method of claim 10, further including storing information associated with the warning event onto the data storage device.

14. The method of claim 10, wherein the data storage device is configured to store work tool identification data including at least one of owner information of the work tool and manufacturer information of the work tool.

15. The method of claim 14, wherein at least one of the work tool identification data, a usage time of the work tool, and the warning event associated with the work tool is encrypted onto the data storage device.

16. The method of claim 10, wherein the work tool is at least one of a bucket, a grappler, a hammer, a fork, a saw, a rotary broom, a shear, or a lifting hook.

17. A data system, comprising:
a work tool configured to be attached to a machine; and
a data storage device located on the work tool, the data storage device being configured to log a warning event associated with the work tool.

18. The data system of claim 17, wherein the data system is configured to store servicing information regarding the work tool.

19. The data system of claim 17, further including at least one sensor, wherein a processing device determines a warning event by communicating with the at least one sensor and comparing the sensor data to set limits.

20. The data system of claim 17, wherein the data storage device is configured to log a usage time of the work tool, and the work tool usage time includes at least one of a current usage time, a total machine usage time, and a lifetime usage time.
